(19) United States
(12) Patent Application Publication
(10) Pub. No.: US 2025/0249569 A1
(43) Pub. Date: Aug. 7, 2025

(54) Insulating Screwdriver Handle Structure

(71) Applicant: WEI CHINS PLASTIC ENTERPRISE CORP., Taichung City (TW)

(72) Inventor: Chia-Wei Lai, Taichung City (TW)

(21) Appl. No.: 19/017,273

(22) Filed: Jan. 10, 2025

(30) Foreign Application Priority Data
Feb. 7, 2024 (TW) 113105031

(51) Int. Cl. B25G 1/12; B25B 15/02; B25B 23/00; B25G 1/08

(52) U.S. Cl. CPC B25G 1/125; B25B 15/02; B25B 23/0035; B25G 1/08

(57) ABSTRACT

An insulating screwdriver handle structure may include a handle, a central shaft, an accommodating member, and at least a screwdriver bit. The handle has a working end and an open end, and an insulator embedded within the working end is connected to a driving member, and the driving member protruding from the working end is adapted to connect to the screwdriver bit. The central shaft comprises a fixed end and a locating end. The driving member and the central shaft are separated by the coating of the insulator, so that the driving member and the central shaft have no direct contact to achieve complete insulation during use, making it relatively safe for application in electrical equipment.

### FIELD OF THE INVENTION

The present invention relates to an insulated screwdriver handle structure and more particularly to an insulated screwdriver handle structure that provides storage for screwdriver bits.

### BACKGROUND OF THE INVENTION

A conventional screwdriver, referring to Taiwan Patent M601169, comprises a main body (1) and a rod body (2). An accommodating space (13) for bits is formed around the main body (1), and the main body (10) also has a working end (14) and an open end (15), and the working end (14) is configured to connect to a driving rod (81) while the open end (15) is connected to a tool bit. The rod body (2) secured with the accommodating space (13) comprises an abutting section (22) and a connecting section (21), and an outer threaded portion is formed on the connecting section (21) to enable the driving rod (81) to be screwed thereon.

However, the conventional screwdriver has following disadvantages: the rod body (2) is directly connected to the driving rod (81) inside the main body (1), which cannot effectively be insulated. Thus, when the screwdriver tool is used for electrical equipment, it remains a risk of electric current being transmitted through the driving rod (81) to the rod body (2), raising concerns about potential electric shock and compromising safety during use. Therefore, there remains a need for a new and improved design for an insulated screwdriver handle structure to overcome the problems presented above.

### SUMMARY OF THE INVENTION

The present invention provides an insulating screwdriver handle structure comprising a handle, a central shaft, an accommodating member, and at least a screwdriver bit. The handle has a working end and an open end, and an insulator embedded within the working end is connected to a driving member, and the driving member protruding from the working end is adapted to connect to the screwdriver bit. When the handle is rotated, the driving member is adapted to drive the screwdriver bit to have synchronous rotation. The central shaft comprises a fixed end and a locating end, and the central shaft has a first peripheral groove and a second peripheral groove respectively formed adjacent to the fixed end and the locating end. The insulator of the handle covers the driving member and the fixed end of the central shaft, so that the central shaft is secured inside the handle, and the central shaft and the handle are adapted to achieve full insulation, so as to enhances safety during use. The accommodating member has a sleeve tube and the elastic ring, and the sleeve tube is connected to a storage rack and a blocking plate, and the storage rack provides a space for storing the screwdriver bit. A plurality of elastic claws are formed on one end of the sleeve tube, and the other end thereof is connected to an end cap. When the sleeve tube is slidably disposed on the central shaft, the elastic claws are configured to engage with the first peripheral groove or the second peripheral groove, and the elastic ring is adapted to tighten the elastic claws, so as to allow the sleeve tube to be positioned when sliding to the maximum sliding position thereof. A stepped periphery formed at one side of an inner tube of the sleeve tube is located adjacent to the elastic claws, and a collar is installed on the locating end of the central shaft, and the outer diameter of the collar is larger than that of the stepped periphery, and is smaller than that of the inner tube. The collar is configured to restrict the sleeve tube so as to prevent the sleeve tube from directly detaching from the central shaft during sliding. When the sleeve tube, along with the storage rack, the blocking plate, and the screwdriver bit, is fully retracted into the handle, the end cap is adapted to close the open end.

Comparing with conventional screwdriver handle structure, the present invention is advantageous because: (i) the driving member and the central shaft are separated by the coating of the insulator, so that the driving member and the central shaft have no direct contact to achieve complete insulation during use, making it relatively safe for application in electrical equipment; and (ii) the elastic ring is adapted to tighten the elastic claws, so that the elastic claws are securely engaged with the first peripheral groove or the second peripheral groove, thereby ensuring excellent positioning performance.

### BRIEF DESCRIPTION OF THE DRAWINGS

FIG. 1 is a three-dimensional assembly view of an insulating screwdriver handle structure of the present invention.

FIG. 2 is a three-dimensional exploded view of the insulating screwdriver handle structure of the present invention.

FIG. 3 is a sectional assembly view of the insulating screwdriver handle structure of the present invention.

FIG. 4 is an enlarged sectional assembly view of the insulating screwdriver handle structure of the present invention.

FIG. 5 is a schematic view illustrating a screwdriver bit is driven out of a handle of the insulating screwdriver handle structure of the present invention.

FIG. 6 is a schematic view illustrating the screwdriver bit is easily picked up for use in the present invention.

FIG. 7 is a s schematic view illustrating a plurality of elastic claws are engaged with a second peripheral groove of the insulating screwdriver handle structure of the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

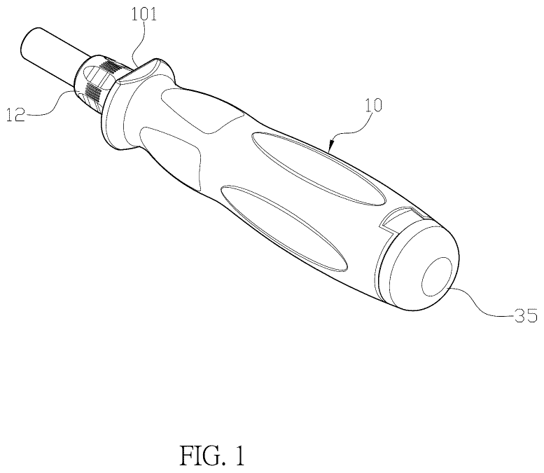

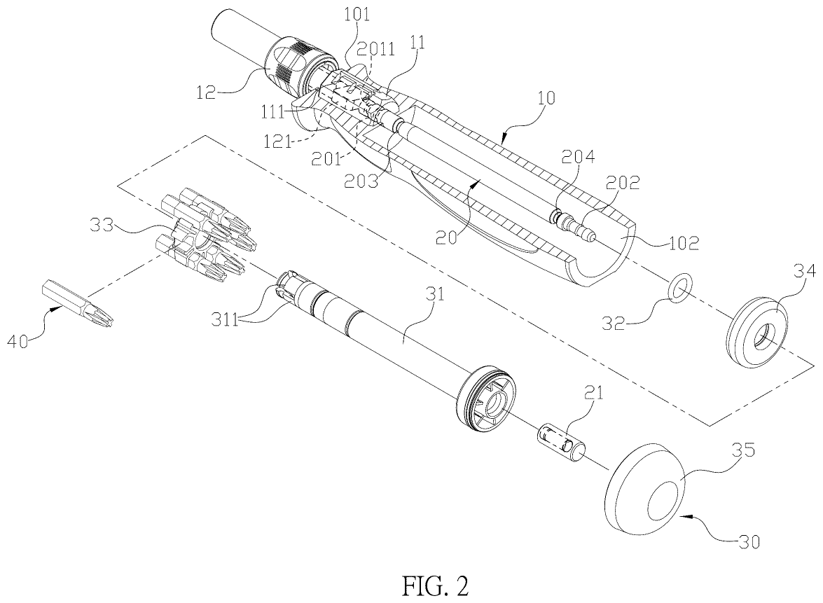

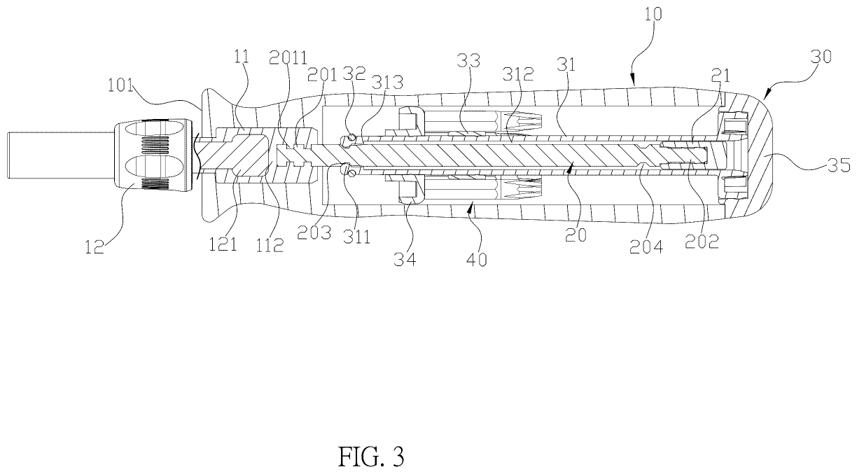

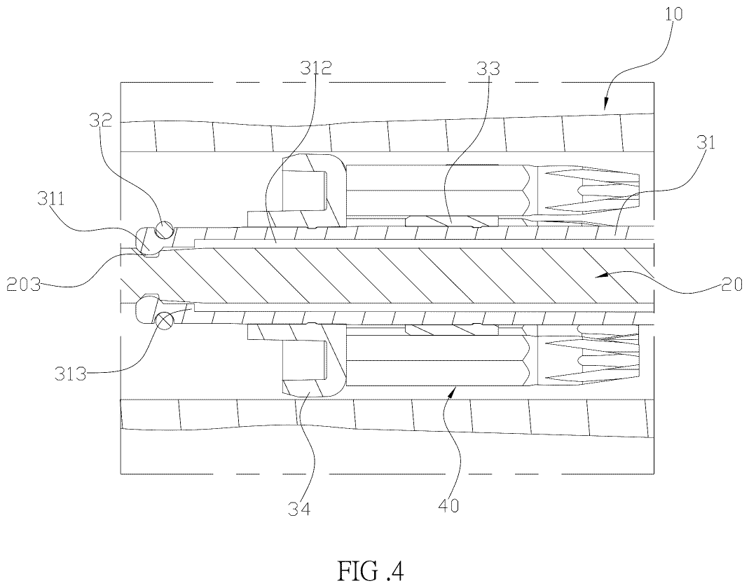

Referring to FIGS. 1 to 4, the present invention provides an insulating screwdriver handle structure comprising a handle (10), a central shaft (20), an accommodating member (30), and at least a screwdriver bit (40). The handle (10) has a working end (101) and an open end (102), and an insulator (11) embedded within the working end (101) is connected to a driving member (12), and the driving member (12) protruding from the working end (101) is adapted to connect to the screwdriver bit (40). Therefore, when the handle (10) is rotated, the driving member (12) is adapted to drive the screwdriver bit (40) to have synchronous rotation. The central shaft (20) comprises a fixed end (201) and a locating end (202), and the central shaft (20) has a first peripheral groove (203) and a second peripheral groove (204) respectively formed adjacent to the fixed end (201) and the locating end (202). The insulator (11) of the handle (10) covers the driving member (12) and the fixed end (201) of the central shaft (20), so that the central shaft (20) is secured inside the handle (10), and the central shaft (20) and the handle (10) are adapted to achieve full insulation, so as to enhances safety during use. The accommodating member (30) has a sleeve tube (31) and the elastic ring (32), and the sleeve tube (31) is connected to a storage rack (33) and a blocking plate (34), and the storage rack (33) provides a space for storing the screwdriver bit (40). A plurality of elastic claws (311) are formed on one end of the sleeve tube (31), and the other end thereof is connected to an end cap (35). When the sleeve tube (31) is slidably disposed on the central shaft (20), the elastic claws (311) are configured to engage with the first peripheral groove (203) or the second peripheral groove (204), and the elastic ring (32) is adapted to tighten the elastic claws (311), so as to allow the sleeve tube (31) to be positioned when sliding to the maximum sliding position thereof. Furthermore, a stepped periphery (313) formed at one side of an inner tube (312) of the sleeve tube (31) is located adjacent to the elastic claws (311). In addition, a collar (21) is installed on the locating end (202) of the central shaft (20), and the outer diameter of the collar (21) is larger than that of the stepped periphery (313), and is smaller than that of the inner tube (312). The collar (21) is configured to restrict the sleeve tube (31) so as to prevent the sleeve tube (31) from directly detaching from the central shaft (20) during sliding. Also, when the sleeve tube (31), along with the storage rack (33), the blocking plate (34), and the screwdriver bit (40), is fully retracted into the handle (10), the end cap (35) is adapted to close the open end (102).

In one embodiment, the insulator (11), formed in polygonal shape, is engaged with the working end (101) of the handle (10) after being embedded.

In another embodiment, the insulator (11) has a slot (111) which is configured to engage with the working end (101) of the handle (10).

In still another embodiment, the driving member (12) is a ratcheting sleeve.

In a further embodiment, the driving member (12) is a normal sleeve.

In still a further embodiment, an enlarged portion (121), formed on the driving member (12), provides the insulator (11) with a larger surface area for coverage.

In a preferred embodiment, a third groove (2011) is formed on the fixed end (201) of the central shaft (20), and the insulator (11) is engaged with the third groove (2011) when covering the central shaft (20).

In another preferred embodiment, when the insulator (11) covers the driving member (12) and the fixed end (201) of the central shaft (20), a blocking wall (112) is formed between the driving member (12) and the fixed end (201) to sufficiently separate the driving member (12) and the fixed end (201).

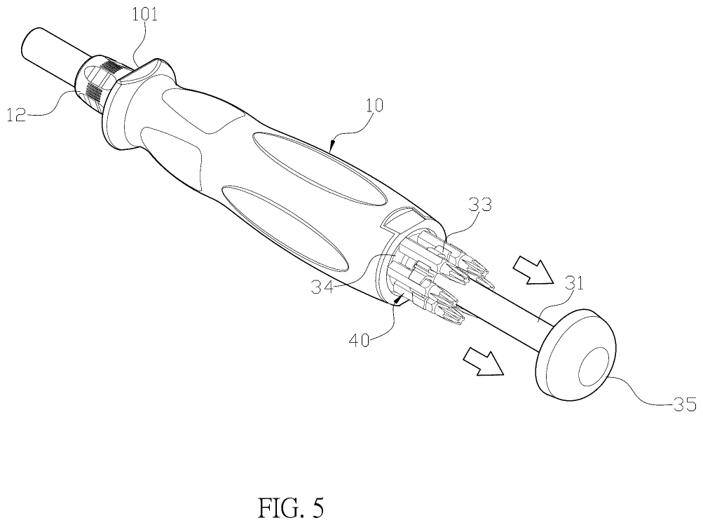

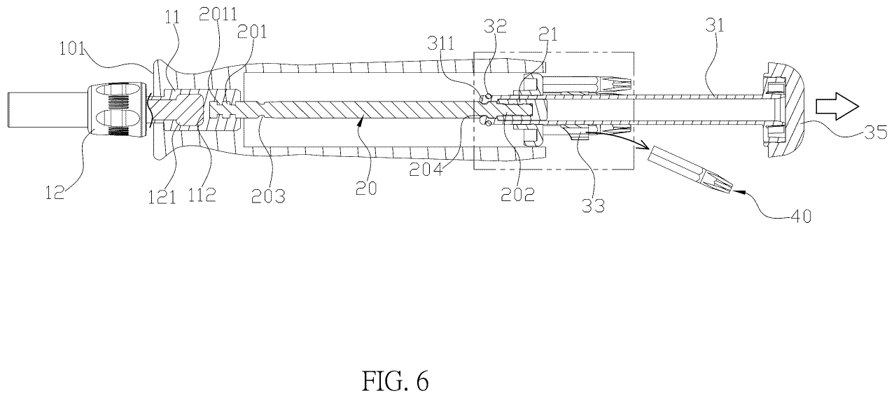

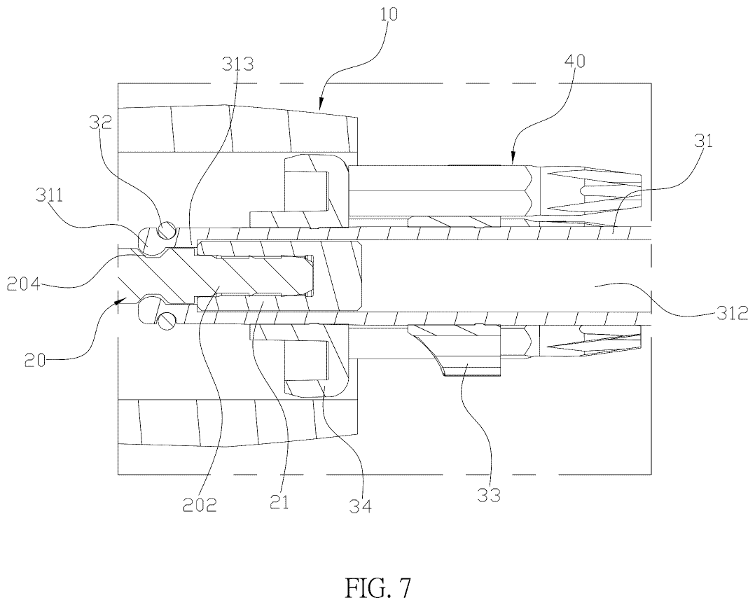

Referring to FIGS. 5 to 7, in actual application, the end cap (35) is pulled to drive the storage rack (33) with the screwdriver bit (40) out of the handle (10) by the combination of the end cap (35) and the sleeve tube (31). Meanwhile, the elastic claws (311) are disengaged from the first peripheral groove (203) to engage with the second peripheral groove (204), so as to allow the sleeve tube (31) along with the storage rack (33) to be securely positioned in an outwardly exposed state, facilitating the pickup and placement of the screwdriver bit (40). When the screwdriver bit (40) is picked up or placed back, the end cap (35) with the sleeve tube (31) is pushed back to allow the end cap (35) to close the open end (102) again, thereby facilitating the use of the screwdriver bit (40).

Comparing with conventional screwdriver handle structure, the present invention is advantageous because: (i) the driving member (12) and the central shaft (20) are separated by the coating of the insulator (11), so that the driving member (12) and the central shaft (20) have no direct contact to achieve complete insulation during use, making it relatively safe for application in electrical equipment; and (ii) the elastic ring (32) is adapted to tighten the elastic claws (311), so that the elastic claws (311) are securely engaged with the first peripheral groove (203) or the second peripheral groove (204), thereby ensuring excellent positioning performance.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. An insulating screwdriver handle structure comprising a handle, a central shaft, an accommodating member, and at least a screwdriver bit;
wherein the handle has a working end and an open end, and an insulator embedded within the working end is connected to a driving member, and the driving member protruding from the working end is adapted to connect to the screwdriver bit; when the handle is rotated, the driving member is adapted to drive the screwdriver bit to have synchronous rotation;
wherein the central shaft comprises a fixed end and a locating end, and the central shaft has a first peripheral groove and a second peripheral groove respectively formed adjacent to the fixed end and the locating end; the insulator of the handle covers the driving member and the fixed end of the central shaft, so that the central shaft is secured inside the handle, and the driving member and the central shaft are separated so as to achieve full insulation of the central shaft and the handle, thereby enhancing safety during use;
wherein the accommodating member has a sleeve tube and the elastic ring, and the sleeve tube is connected to a storage rack and a blocking plate, and the storage rack provides a space for storing the screwdriver bit; a plurality of elastic claws are formed on one end of the sleeve tube, and the other end thereof is connected to an end cap; when the sleeve tube is slidably disposed on the central shaft, the elastic claws are configured to engage with the first peripheral groove or the second peripheral groove, and the elastic ring is adapted to tighten the elastic claws, so as to allow the sleeve tube to be positioned when sliding to the maximum sliding position thereof; a stepped periphery formed at one side of an inner tube of the sleeve tube is located adjacent to the elastic claws, and a collar is installed on the locating end of the central shaft, and the outer diameter of the collar is larger than that of the stepped periphery, and is smaller than that of the inner tube; the collar is configured to restrict the sleeve tube so as to prevent the sleeve tube from directly detaching from the central shaft during sliding; when the sleeve tube, along with the storage rack, the blocking plate, and the screwdriver bit, is fully retracted into the handle, the end cap is adapted to close the open end.

2. The insulating screwdriver handle structure of claim 1, wherein the insulator, formed in polygonal shape, is engaged with the working end of the handle after being embedded.

3. The insulating screwdriver handle structure of claim 1, wherein the insulator has a slot which is configured to engage with the working end of the handle.

4. The insulating screwdriver handle structure of claim 1, wherein an enlarged portion, formed on the driving member, provides the insulator with a larger surface area for coverage.

5. The insulating screwdriver handle structure of claim 1, wherein a third groove is formed on the fixed end of the central shaft, and the insulator is engaged with the third groove when covering the central shaft.

6. The insulating screwdriver handle structure of claim 1, wherein when the insulator covers the driving member and the fixed end of the central shaft, a blocking wall is formed between the driving member and the fixed end to separate the driving member and the fixed end.
